(19) United States
(12) Patent Application Publication
(10) Pub. No.: US 2014/0246470 A1
(43) Pub. Date: Sep. 4, 2014

(54) SINGLE-POINT AMBIDEXTROUS BREAKAGE SYSTEM FOR CERAMIC CUTTING MACHINES

(71) Applicant: BELLOTA HERRAMIENTAS, S.A., Legazpia (Guipuzcoa) (ES)

(72) Inventor: Josep BARO CABRERO, Legazpia (ES)

(73) Assignee: BELLOTA HERRAMIENTAS, S.A., Legazpia (Guipuzcoa) (ES)

(21) Appl. No.: 14/191,647

(22) Filed: Feb. 27, 2014

(30) Foreign Application Priority Data
Mar. 1, 2013 (ES) P201330291

(51) Int. Cl. B28D 1/22

(52) U.S. Cl. CPC B28D 1/225
USPC 225/96.5

(57) ABSTRACT

The object of the present invention relates to a breakage system applied to ceramic cutting machines, which configuration and design allows it to be used by right-handed or left-handed people.

This breakage system solves the unresolved problem in the present state of the art with respect to the use of the cutting machine, such that it facilitates the cutting process regardless if the operator is right-handed or left-handed.

This invention is especially applicable to the construction industry.

### OBJECT OF THE INVENTION

The object of the present invention relates to a breakage system applied to ceramic cutting machines, which configuration and design allows it to be used by right-handed or left-handed people.

This invention is especially applicable to the construction industry.

### TECHNICAL PROBLEM TO BE SOLVED AND BACKGROUND OF THE INVENTION

Single-point breakage systems in ceramic cutting machines are currently located between the two guides of said machines, on which a sliding carriage, carrying the cutting tool (known as a scoring wheel), moves.

The foregoing is due to the fact that once the ceramic is traced, it must be broken through one of the extremities of the tracing that is made.

The problem lays in that the actuating lever of the breakage system, which function is to break and separate the ceramic pieces, often interferes with the sliding carriage between the guides of the cutting machine, thereby complicating the tracing and breakage processes of the ceramic piece.

Likewise, there are cutting machines with the lever placed on the right side of the guides, which is problematic for left-handed users.

The present invention solves the unresolved problem in the present state of the art with respect to the use of the cutting machine, such that it facilitates the cutting process regardless if the operator is right-handed or left-handed.

This new invention reduces the number of movements when tracing and splitting the ceramic pieces, given that it allows tracing it with one hand and breaking the ceramic piece with the other, without the need to release the actuating lever of the breakage system.

### DESCRIPTION OF THE INVENTION

The present invention relates to an ambidextrous breakage system for ceramic cutting machines.

The invention comprises the following: an actuating lever, which is extractable; a through shaft; a cam; a die, located in the lower part of the breakage system below the supporting plane of the piece to be cut; and a separator in the upper part of the breakage system, which in turn comprises a ram.

The through shaft protrudes towards the exterior sides of the guides, there being a hole at each extremity of said through shaft to which the actuating lever is coupled, due to which the activation of the breakage system can be carried out from either side of the guides, either from the left or from the right, regardless if the operator is left-handed or right-handed.

The actuating lever is coupled by pressure or by screwing to the through shaft, which is installed in a casing that facilitates the guiding thereof. This way, the through shaft rotates with the activation of said actuating lever of the breakage system, which moves the cam. In turn, the cam moves the separator and the die (by means of contact with the bearings of the separator and the die, used to reduce the force applied during the separation) towards the direction of the ceramic piece.

The separator comprises a ram in its free extremity and said ram comprises a lateral ridge on each side, each ridge being at each side of the traced line, such that when the die is pressed together with said ridges of the ram on the ceramic piece, the breakage thereof takes place.

The die, which remains hidden in the standby position until it receives the force from the actuating lever, contains a small pyramidal-shaped protrusion in the free extremity, where said protrusion lifts and pushes the traced ceramic piece against the lateral ridges of the separator.

The lateral ridges of the ram have plastic pieces arranged with the purpose of preventing damages to the surface of the ceramic piece during the breakage operation.

### BRIEF DESCRIPTION OF THE FIGURES

In order to complete the description and with the purpose of aiding a better comprehension of the characteristics of the invention, a set of drawings have been attached to this specification as an integral part thereof, which represent the following in an illustrative rather than limitative manner:

FIG. 1 shows a view of the ceramic piece cutting machine, representing the guides, the sliding carriage and an actuating lever of the breakage system of the invention, incorporated in the right side of the cutting machine.

FIG. 2 is a view of the extractable actuating lever of the breakage system with its two placement possibilities, either on the right side or on the left side. The figures show how the lever on the right side appears as a continuous stretch, applicable to right-handed people, while the one on the left appears as a discontinuous stretch, applicable to left-handed people.

FIG. 3a shows a detailed view of the die, the lower part of the breakage system of the cutting machine, with its different pieces, as well as the cam, the protrusion and the through shaft.

FIG. 3b shows an overall view of the die and the separator, where the mechanism activating the actuating lever of the breakage system through the contact between the cam and the bearings of the die and the separator may be observed.

FIG. 3c shows the set of the die and the separator once the casing covering the same is mounted.

FIGS. 3a, 3b and 3c are represented with the actuating lever of the breakage system installed on the right side.

The following is a list of the different elements represented in the figures integrating the invention:
1. Ceramic piece cutting machine.
2. Base of the cutting machine.
3. Sliding carriage.
4. Guides.
5. Ceramic piece.
6. Cam.
7. Separator.
8. Die.
9. Actuating lever of the breakage system.
10. Plastic pieces.
11. Upper casing.
12. Lower casing.
13. Through shaft.
14. Protrusion.
15. Ram.
16. Lateral ridges.
17. Hole.
18. Bearings.
19. Turret.

### DETAILED DESCRIPTION

Ceramic cutting machines (1) are generally constituted by a base (2) on which guides (4) are mounted and through which a sliding carriage (3) moves longitudinally. Turrets (19) are arranged at both extremities of the base (2) of the cutting machine (1), where the extremities of the guides (4) are inserted. The sliding carriage (3) carries the cutting tool (known as a scoring wheel), in charge of tracing the ceramic piece (5). Once the tracing is complete on said ceramic piece (5), the same is broken by means of a breakage system.

The present invention comprises: an extractable actuating lever (9), which activates the breakage system; a through shaft (13); a cam (6); a die (8), located in the lower part of the breakage system below the supporting plane of the piece to be cut; and a separator (7) in the upper part of the breakage system, which in turns comprises a ram (15).

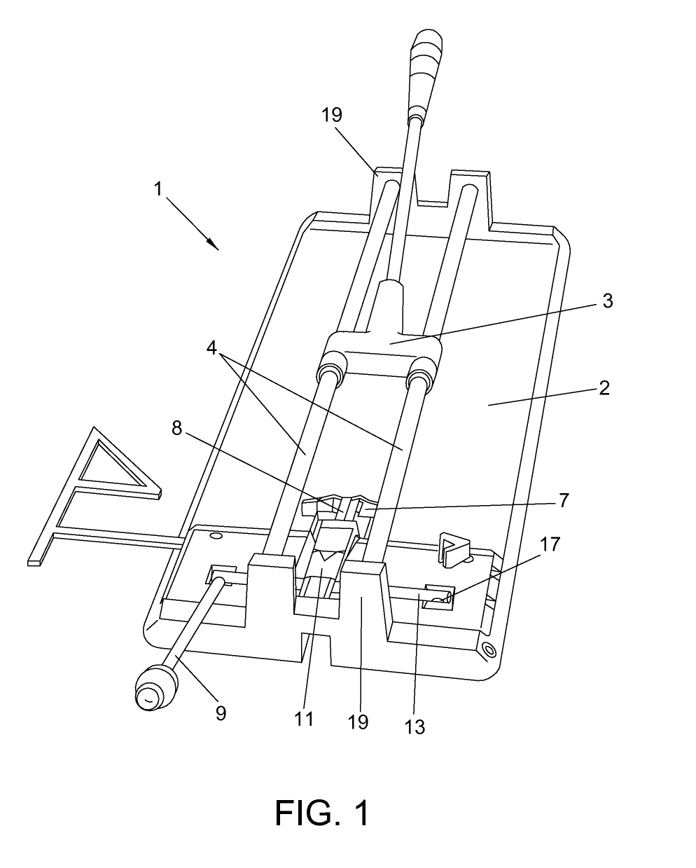

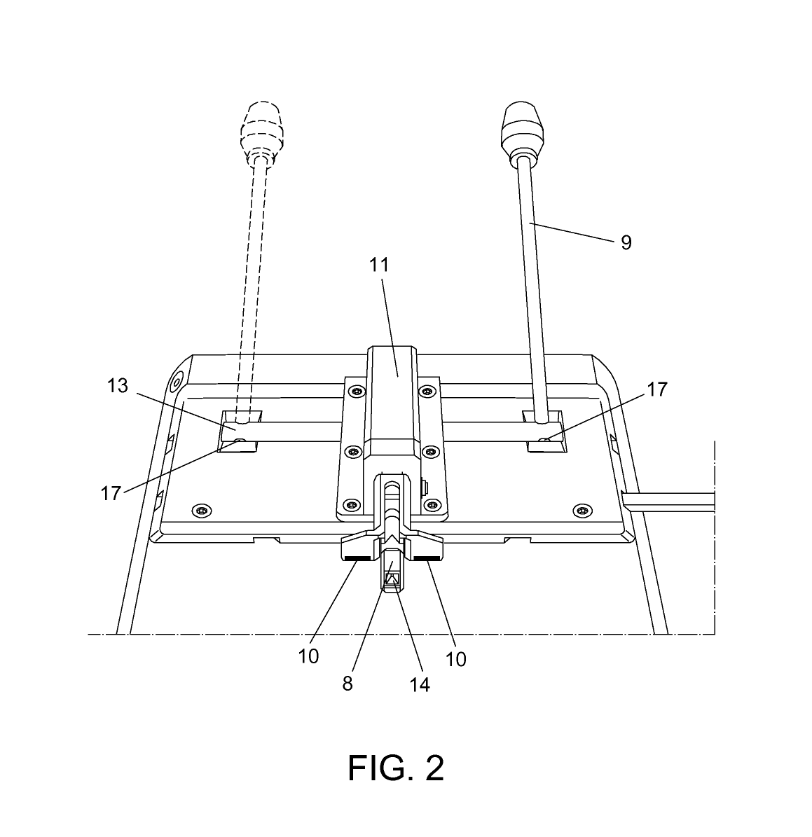

As shown in FIGS. 1 and 2, the actuating lever (9) of the die (8) has been displaced towards the exterior of the guides (4) in the breakage system object of the invention. Said actuating lever (9) is extractable. This way, the path of the sliding carriage (3) is cleared such that it does not interfere with said lever (9).

Likewise, given that the actuating lever (9) may be coupled to both sides of the guides (4), it may be used indistinctly by right-handed or left-handed people.

In order to displace the lever (9) towards the exterior of the guides (4), the through shaft (13) to which it is joined has been lengthened.

Said through shaft (13) comprises, at each extremity thereof, a hole (17) to which the actuating lever (9) of the die (8) is coupled, either by pressure or by screwing.

Another advantage of locating the actuating lever (9) on one side of the guides (4) is that it allows exercising the tracing with one hand and breaking the ceramic piece (5) through the breakage system with the other in a more ergonomic manner, thereby reducing the number of movements and actions to carry out the tracing and breakage of ceramic pieces (5).

Both the die (8) and the ram (15) of the separator (7) have bearings (18) in the area of contact with the cam (6) to facilitate the displacement and reduce the force to be applied to carry out the breakage of the ceramic piece (5).

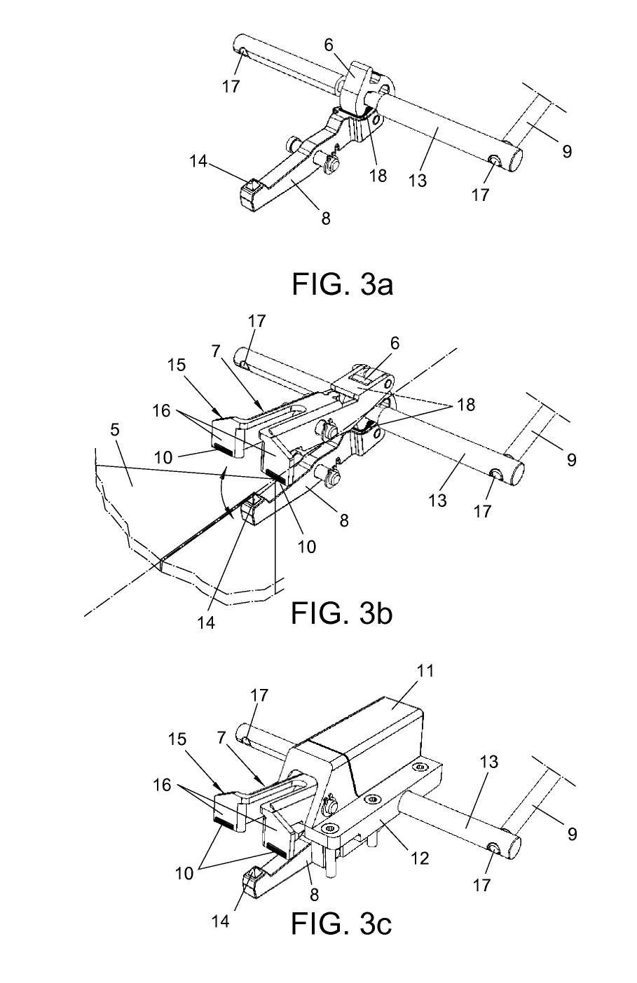

FIGS. 3a, 3b and 3c show how the breakage system comprises the die (8) in its lower part, while the upper part comprises a separator (7). The die (8) is located below the supporting plane of the piece (5) to be cut. Both the separator (7) and the die (8) apply the necessary force on the traced ceramic piece (5) to break the ceramic piece (5) through the tracing that is made. The set of both (7, 8) is guided through the lower casing (12).

By activating the actuating lever (9) of the breakage system, the through shaft (13) rotates and activates the movement of the cam (6), which in turn displaces the separator (7) and the die (8), by means of the use of the bearings (18), towards the ceramic piece (5).

As shown in FIG. 3b, the separator (7) comprises the ram (15) and two lateral ridges (16), each ridge (16) being located at each side of the tracing that is made. By moving the actuating lever (9), the die (8) and the separator (7) move closer to each other, exerting pressure on the ceramic piece (5) and producing the breakage thereof due to the tracing that was previously made.

FIG. 3a shows how the die (8) comprises, at its free extremity, a small pyramidal-shape protrusion (14), where said protrusion (14) lifts and pushes the traced ceramic piece (5) against the lateral ridges (16) of the ram (15), thereby facilitating the breakage due to the tracing of said ceramic piece (5). Said die (8) remains hidden in the standby position until it is activated by the actuating lever (9).

FIGS. 3b and 3c show plastic pieces (10) arranged at the lateral ridges (16) of the ram (15), with the purpose of preventing damages to the surface of the ceramic pieces (5) during the breakage operation upon the exertion of pressure by the ridges (16) on the ceramic piece (5).

The present invention should not be limited to the embodiment described herein. Other configurations may be carried out by experts in the art based on the present description. Therefore, the scope of the invention is hereby defined by the following claims.

1. Single-point ambidextrous breakage system for ceramic cutting machines (1) that comprises:
a sliding carriage (3),
guides (4),
an actuating lever (9),
a through shaft (13),
a cam (6),
a die (8), located in the lower part of the breakage system below the supporting plane of a piece (5) to be cut,
a separator (7) in the upper part of the breakage system, which in turn comprises a ram (15), and
bearings (18),
characterized in that:
the through shaft (13) protrudes towards the exterior sides of the guides (4), there being a hole (17) at each extremity of said through shaft (13) to which the extractable actuating lever (9) is coupled, due to which the activation of the breakage system can be carried out from either side of the guides (4), either from the left or from the right, regardless if the operator is left-handed or right-handed.

2. Single-point ambidextrous breakage system for ceramic cutting machines (1) according to claim 1, characterized in that the actuating lever (9) is coupled to the through shaft (13) by pressure.

3. Single-point ambidextrous breakage system for ceramic cutting machines (1) according to claim 1, characterized in that the actuating lever (9) is coupled to the through shaft (13) by screwing.

4. Single-point ambidextrous breakage system for ceramic cutting machines (1) according to claim 2, characterized in that the through shaft (13) is fastened to a lower casing (12), which facilitates the guiding thereof.

5. Single-point ambidextrous breakage system for ceramic cutting machines (1) according to claim 4, characterized in that the separator (7) comprises the ram (15) in its free extremity.

6. Single-point ambidextrous breakage system for ceramic cutting machines (1) according to claim 5, characterized in that the ram (15) comprises two lateral ridges (16), arranged on each side of the tracing made on the ceramic piece (5), where said ridges (16) push the ceramic piece on the die (8).

7. Single-point ambidextrous breakage system for ceramic cutting machines (1) according to claim 6, characterized in that the die (8) comprises, in its free extremity, a small pyramidal-shaped protrusion (14) with a flattened tip, where said protrusion (14) lifts and pushes the traced ceramic piece (5) against the lateral ridges (16) of the separator (7).

8. Single-point ambidextrous breakage system for ceramic cutting machines (1) according to claim 7, characterized in that the lateral ridges (16) of the ram (15) have plastic pieces (10) arranged thereon.

9. Single-point ambidextrous breakage system for ceramic cutting machines (1) according to claim 3, characterized in that the through shaft (13) is fastened to a lower casing (12), which facilitates the guiding thereof.
